(19) United States
(12) Patent Application Publication
(10) Pub. No.: US 2007/0255944 A1
(43) Pub. Date: Nov. 1, 2007

(54) Method for Remotely Authenticating a User

(75) Inventors: Anne Lise Buscaylet, Saint -Cloud (FR); Francois Moreau, The Peak (HK); Jean Bouffard, Sceaux (FR)

Correspondence Address: STEVENS DAVIS MILLER & MOSHER, LLP, 1615 L STREET, NW, SUITE 850, WASHINGTON, DC, 20036, US

(73) Assignee: HSBC FRANCE, Paris (FR)

(21) Appl. No.: 11/630,794

(22) PCT Filed: Jul. 1, 2005
(86) PCT No.: PCT/FR05/01684

§ 371 Date: Dec. 27, 2006

(30) Foreign Application Priority Data
Jul. 2, 2004 (FR) 0407367

(51) Int. Cl. G06F 21/00

(52) U.S. Cl. 713/155

(57) ABSTRACT

The inventive method for remotely authenticating a user (2) by a provider (1) consists a) in transmitting an identifier (Id) from the user (2) to the provider (1), in determining a code (C) processing rule (R) by the supplier, wherein said code (C) is available to the user (2) and the provider (1), c) in transmitting the code (C) processing rule (R) from the provider (1) to the user (1), d) in processing the code (C) by the user (2) by means of the processing rule (R) in order to obtain first authentication data (A1), e) in transmitting said first authentication data (A1) from the user to the provider (1) and independently of the previous stages from c) to e), f) in processing said code (C) by the provider (1) by means of the processing rule (R) in such a way that second authentication data (A2) is obtainable and g) in comparing said first (A1) and second (A2) authentication data by the provider (1).

The invention relates to a method of remote authentication of a user by a provider.

Banks offer their customers remote services, for example via the Internet or by telephone, without requiring the customers to meet bank staff. To access the services of the bank remotely, a customer must first state his identity, for example by communicating an identifier comprising 11 characters, and then give a password that is normally known only to him and to his bank. The password is conventionally a series of five characters that the user knows by heart. The password is transmitted in its entirety to the bank.

The bank then verifies in its databases whether the password corresponds to the identifier supplied. If this is not the case, an attempt at identity theft is very probable and the service request is refused. If the password matches the identifier supplied, the bank authorizes the customer to access the required service, for example to manage his account.

The authentication and identification procedure described hereinabove is not protected from fraudulent access if a third party succeeds in discovering the “identifier-password” pair, however. Certain services can therefore not be made accessible remotely without additional security measures.

For example, to be able to effect an open transfer remotely, for example from a first bank to a second bank, the customer must beforehand visit the first bank to register there the account details of the account to receive the transfer. This procedure is not satisfactory for a customer who has chosen remote banking. All the more so in that the bank does not necessarily have a branch near the customer.

To avoid this problem, banks therefore use complementary authentication tests that can be effected remotely. For example, bank staff request the person's date or place of birth. The confidentiality of such information is very limited, however. The number of possible tests is also small. The level of security conferred by these complementary authentication tests is therefore weak.

There therefore exists a requirement for a complementary authentication method that is simple to implement and reliable. The object of the invention is to satisfy that requirement.

According to the invention, this object is achieved by means of a method of remote authentication of a user by a provider, including the following steps:

a) transmission from said user to said provider of an identifier,

b) determination by said provider of a processing rule applicable to a code consisting of characters available to said user and said provider,

c) transmission from said provider to said user of said processing rule,

d) processing of said code by said user by means of said processing rule to obtain first authentication data,

e) transmission from said user to said provider of said first authentication data,

and, independently of the steps b) to e),

f) recovery by said provider of said code, preferably on the basis of said identifier,

g) processing of said code by said provider by means of said processing rule to obtain second authentication data,

and, after reception of said first authentication data and determination of said second authentication data,

h) comparison of said first and second authentication data by said provider.

Thus the code available to the user and to the provider is not transmitted. Only the result of processing this code in accordance with a processing rule determined by the provider is transmitted to the provider. Even if he recovers this result, a third party therefore cannot determine the code. The authentication procedure according to the invention therefore ensures very high security. Thus very reliable authentication is advantageously possible remotely.

To implement the method according to the invention, only one code has to be communicated to the user. The method according to the invention is therefore advantageously very simple and of low cost.

The method according to the invention also has the following preferred features:

Said code is specific to said user.

Said code takes the form of a series of characters, preferably a series of digits, preferably imprinted on a credit card type card.

Said series of characters includes at least 10 characters, preferably at least 15 characters, more preferably 16 characters.

Said processing rule is modified each time the method according to the invention is executed. The processing rule is preferably determined at random.

Said processing rule specifies how to select at least one character from said characters constituting said code.

Said processing rule identifies said at least one character to be selected by supplying a position of said at least one character in said code.

Said processing rule identifies a plurality of characters to be selected by supplying their positions in said code.

Said position(s) indicated by said processing rule is/are modified each time the method according to the invention is executed, the number of positions preferably being constant.

Said processing rule indicates the order in which said selected characters must be sorted to form said first authentication data.

According to said processing rule, said characters identified by their respective positions in said code must be extracted from said code and, said positions being supplied in order, said extracted characters must be put into an order in accordance with the order of said positions.

In the step a), said user further transmits to the provider a password and after reception of said password said provider effects a preliminary authentication of said user by means of said password. The steps b) to h) are preferably executed only if said preliminary authentication succeeds.

Said provider is a banking establishment or a trader offering goods or services over the Internet.

Communications between said provider and said user are effected electronically, for example via the Internet network, orally, for example via a telephone network, or by mail.

In the step h), if said first and second authentication data are different, said provider does not recognize said user as acceptable.

After a particular number of unsuccessful authentication attempts, for example three attempts, said provider refuses any new attempt by said user identified by said identifier.

All communications between the provider and user are encrypted.

Other features and advantages of the present invention will become apparent on reading the following description and examining the appended drawing in which

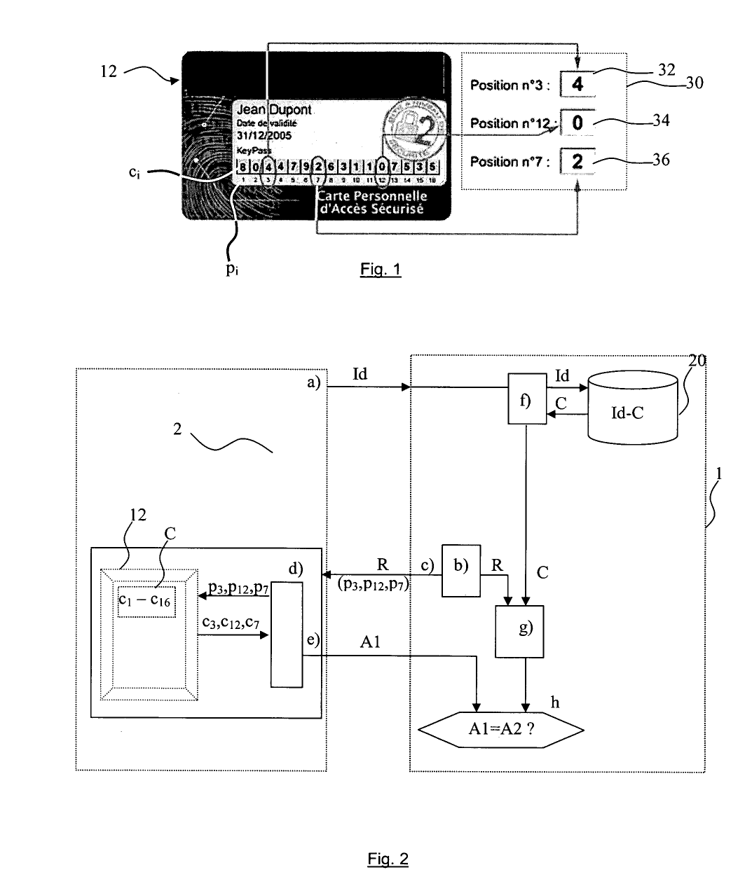

FIG. 1 represents a carrier for an authentication code that can be used to implement a method according to the invention;

FIG. 2 represents diagrammatically the steps of an authentication method according to the invention.

Refer now to FIG. 2. In that figure, the letters a) to h) correspond to the steps of the method according to the invention.

Following the reception of a request to access a service or to purchase a product, a provider 1, for example a bank, proceeds to a first step of identification of the user 2 who submitted the request. During this first step (step a)), the user 2 states his identity, for example by communicating to the provider 1 an identifier Id, conventionally in the form of a series of 11 characters, generally digits.

A confidential password M, conventionally consisting of a series of five characters memorized by the user 2, may also be requested of the user 2 in order for the provider 1 to be able to proceed to a preliminary authentication. To this end, the provider 1 verifies if the password M received is indeed that supplied confidentially to the person identified by the identifier Id. If this is not the case, the request from the user 2 is refused. Otherwise, the provider 1 executes the complementary authentication method according to the invention in the following manner.

Before the execution of the method according to the invention, a personalized code C must have been communicated to the user, for example by ordinary mail. As will emerge in more detail in the remainder of the description, the longer the code C, the greater the number of different “questions”, referred to hereinafter as “processing rules”, the provider 1 can put to the user 2 to authenticate him. For the number of these rules to be high, and the authentication security therefore very reliable, the code C therefore has a length that makes it difficult to memorize. The code C preferably contains at least 10, preferably at least 15, more preferably 16 characters c₁-c₁₆ in order. The code C being necessary for each occurrence of the authentication method according to the invention, it is preferably affixed to a carrier 12, for example onto a card like that represented in FIG. 1.

Each user 2 preferably has a card 12 carrying a unique code C. That card is personal to him and he must not disclose the code C. Apart from the user 2, only the provider 1 knows the code C and the link between the code C and the user 2. To this end, the provider can maintain a database 20 containing all of the “code C-identifier Id” pairs of its customers, a unique identifier Id being assigned to each customer.

If the optional preliminary authentication procedure succeeds, the provider 1 determines a processing rule R adapted to extract information “hidden” in the code C (step b)). The processing rule preferably changes on each execution of the method according to the invention, preferably at random. The modifications made to the processing rule are preferably minor modifications, however, so as not to disorient the user 2.

The provider 1 then transmits to the user 2 to be authenticated the processing rule R, the user 2 having to apply that rule to the code C that he holds in order to constitute first authentication data Al (step c)). If the user 2 has the code C, he then processes it according to the processing rule R (step d)) and informs the provider 1 of the result of that processing by means of valid first authentication data A1 (step e)).

A “processing rule” R is a set of instructions specifying how, starting from the code C, to constitute valid authentication data.

“Valid authentication data” is data carrying the “hidden” information extracted from the code C by means of the processing rule R.

The processing rule R preferably gives the respective positions of a certain number of characters cᵢ of the code C and requests the user 2 to identify in the code C the corresponding characters cᵢ and then to associate them with said positions. The processing rule R is then limited to the extraction from the code C of characters cᵢ designated by their positions pᵢ in the code C. Only the person having the card 12 can determine the characters cᵢ designated in this way.

In the case of communication via the Internet, as represented in FIG. 1, the provider 1 may for example request that he be transmitted the third, twelfth and seventh characters of the code C by sending the user 2 a dialog box 30 containing three input areas 32, 34 and 36 labeled, for example, “position N′3”, “position No 2” and “position No 7” respectively. The user 2 then identifies in the code C on his card 12 the characters c₃, c₁₂ and c₇ occupying those positions, namely “4”, “0” and “2”, respectively (see FIG. 1). The user 2 then enters them in the input areas 32, 34 and 36, respectively, and then confirms his input.

The first authentication data A1 is then generated automatically, preferably encrypted and sent to the provider 1. If it is valid, the first authentication data A1 carries the information to the effect that the character “4” is the character in third position, the character “0” is the character in twelfth position, and the character “2” is the character in seventh position. In the case of the preferred processing rule, valid authentication data is therefore information specifying which characters correspond, in the code C, to the positions designated in the processing rule R sent by the provider 1 to the user 2 in order to proceed to his authentication.

Sending a dialog box including a set of input areas labeled by means of the positions of the characters that the user 2 must enter therein has the advantage of being particularly simple. It is further advantageous if such a dialog box enables the positions pᵢ and therefore the series of characters cᵢ entered to be put in order. The processing rule R then requests the user 2 not only to identify in the code C the characters cᵢ corresponding to the positions pᵢ transmitted, but also to order them by entering them in the corresponding input areas. The probability that the user 2 can supply valid authentication data A1 without knowing the code C is then further reduced.

In the case of authentication effected by telephone, the first authentication data A1 may simply be provided by stating that the characters at the positions 3, 12 and 7 are “4”, “0” and “2”, respectively.

As explained hereinabove, the processing rule R is preferably modified on each execution of the method according to the invention (step b)). Preferably only the positions pᵢ used to designate the characters to be extracted from the code C are modified, the number of characters to be extracted from the code C being constant. Thus the user 2 is advantageously always authenticated in a similar manner. This advantageously enhances the acceptability of the authentication procedure to the user. The number of different processing rules that it is possible to construct on this model is directly proportional to the number of characters constituting the code C and the number of characters to be extracted therefrom. However, the number of characters to be extracted from the code C is preferably always fewer than 5, more preferably equal to 3. This has the advantage that the authentication procedure is therefore faster.

Because of the modification of the processing rule R on each execution of the method according to the invention, the information on the “character cᵢ-position pᵢ of the character cᵢ in the code C” pairs transmitted by the user 2 to the provider 1 by means of the first authentication data A1 are different from one use of the method to the next. The knowledge of first valid authentication data A1 resulting from a first execution of the method according to the invention therefore advantageously does not make it possible to deduce what this data should be on a subsequent execution of the invention.

Finally, unlike a password, the code C is normally never communicated in its entirety by the user 2 to the provider 1. Even if a third party obtains access to first valid authentication data A1, he could not deduce the code C from it.

Providing in order the characters cᵢ of the code C designated by their respective positions pᵢ in the code C is a particularly simple processing rule R that advantageously necessitates no particular knowledge on the part of the user 2. Other processing rules may equally be envisaged, however. For example, the processing rule could be to extract the characters designated by a particular color, shape or size and to put them into an order according to their respective positions in the code. The designation could also be effected by delivering “abscissa-ordinate” pairs for finding the characters in a table imprinted on the card. More complex rules, for example involving operations between designated characters to supply other characters and then form the first authentication data A1 may equally be envisaged.

After identifying the user 2, preferably by means of the identifier Id, the provider 1 recovers the code C in the database 20, for example by means of the identifier Id entered by the user 2 (step f)). The provider 1 then applies the processing rule R to the code C to determine second authentication data A2 (step g)). The determination of the second authentication data A2 is independent of that of the first authentication data A1 and may be effected before the provider 1 sends the processing rule R or during or after the determination and sending of the first authentication data A1 by the user 2.

The provider then compares the first and second authentication data (step h)). If the first and second authentication data are identical, the first authentication data A1 is valid. The user 2 has therefore correctly provided the characters designated in accordance with the processing rule R and the provider 1 considers that the authentication has succeeded. Consequently it authorizes the user 2 to access the requested service.

If not, that access is refused. The provider 1 preferably authorizes a plurality of successive attempts at authentication according to the method of the invention, for example three attempts. If all the attempts fail, the provider 1 considers that the failures are not reading or input errors by the user 2, but that the user 2 does not have the code C. Consequently, the provider 1 refuses any subsequent authentication attempt, at least until the situation has been clarified, for example by a meeting with the user 2.

The code C never being transmitted in its entirety during the execution of the method according to the invention, its confidentiality cannot be destroyed by such execution. As is now clearly apparent, the invention therefore provides an authentication method that is simple to implement and reliable.

Of course, the invention is not limited to the embodiment described hereinabove. In particular, the number of characters cᵢ of the code C, their nature (digits and/or letters), the number of characters to enter to be authenticated and the nature of the carrier (card or otherwise) may be different from those described.

Locking out after a certain number of failed attempts is also optional.

Similarly, it is theoretically possible to be authenticated only by means of the method according to the invention described hereinabove, without having given a password beforehand during a preliminary authentication procedure.

The preferred field of application is the banking field, but is not limited thereto. Any transaction necessitating strengthened authentication may advantageously use the method according to the invention.

1-10. (canceled)

11. Method of remote authentication of a user by a provider, including the following steps:
a) transmission from said user to said provider of an identifier,
b) determination by said provider of a processing rule applicable to a code consisting of characters available to said user and said provider,
c) transmission from said provider to said user of said processing rule,
d) determination by said user of at least one character of said code identifiable by its position in said code, said position being supplied by said processing rule to obtain first authentication data,
e) transmission from said user to said provider of said first authentication data,
and, independently of the steps b) to e),
f) recovery by said provider of said code,
g) processing of said code by said provider by means of said processing rule to obtain second authentication data,
and, after reception of said first authentication data and determination of said second authentication data,
h) comparison of said first authentication data and said second authentication data by said provider.

12. Method according to claim 11, wherein, in the step c), said processing rule is determined at random.

13. Method according to claim 11, wherein said code is affixed to a carrier.

14. Method according to claim 13, wherein said code is imprinted on a credit card type card.

15. Method according to claim 11, wherein said processing rule identifies a plurality of characters to be selected by supplying their positions in said code.

16. Method according to claim 15, wherein, according to said processing rule, said characters identified by their respective positions in said code must be extracted from said code and, said positions being supplied in order, said extracted characters must be put into an order according to the order of said positions.

17. Method according to claim 11, wherein in the step a) said user further transmits to the provider a password and after reception of said password said provider effects a preliminary authentication of said user by means of said password.

18. Method according to claim 11, wherein communication between said provider and said user is effected electronically, orally or by mail.

19. Method according to claim 11, wherein after a particular number of failed authentication attempts said provider refuses any new attempt by said user identified by said identifier.

20. Use of a method according to claim 11 for the remote authentication of a user by a banking establishment or a trader offering goods or services over the Internet.

21. Method according to claim 12, wherein said code is affixed to a carrier.

22. Method according to claim 12, wherein said processing rule identifies a plurality of characters to be selected by supplying their positions in said code.

23. Method according to claim 12, wherein in the step a) said user further transmits to the provider a password and after reception of said password said provider effects a preliminary authentication of said user by means of said password.

24. Method according to claim 12, wherein communication between said provider and said user is effected electronically, orally or by mail.

25. Method according to claim 12, wherein after a particular number of failed authentication attempts said provider refuses any new attempt by said user identified by said identifier.

26. Use of a method according to claim 12 for the remote authentication of a user by a banking establishment or a trader offering goods or services over the Internet.

27. Use of a method according to claim 13 for the remote authentication of a user by a banking establishment or a trader offering goods or services over the Internet.

28. Use of a method according to claim 14 for the remote authentication of a user by a banking establishment or a trader offering goods or services over the Internet.

29. Use of a method according to claim 15 for the remote authentication of a user by a banking establishment or a trader offering goods or services over the Internet.

30. Use of a method according to claim 16 for the remote authentication of a user by a banking establishment or a trader offering goods or services over the Internet.

31. Use of a method according to claim 17 for the remote authentication of a user by a banking establishment or a trader offering goods or services over the Internet.

32. Use of a method according to claim 18 for the remote authentication of a user by a banking establishment or a trader offering goods or services over the Internet.

33. Use of a method according to claim 19 for the remote authentication of a user by a banking establishment or a trader offering goods or services over the Internet.

34. Method according to claim 21, wherein said code is imprinted on a credit card type card.

35. Method according to claim 22, wherein, according to said processing rule, said characters identified by their respective positions in said code must be extracted from said code and, said positions being supplied in order, said extracted characters must be put into an order according to the order of said positions.
